(19) United States
(12) Patent Application Publication
(10) Pub. No.: US 2011/0164857 A1
(43) Pub. Date: Jul. 7, 2011

(54) SYSTEMS AND METHODS FOR NETWORK-BASED BOOKMARKING

(75) Inventor: George Foti, Dollard-des-Ormeaux (CA)

(73) Assignee: TELEFONAKTIEBOLAGET L M ERICSSON (PUBL), Stockholm (SE)

(21) Appl. No.: 12/844,010

(22) Filed: Jul. 27, 2010

Related U.S. Application Data
(60) Provisional application No. 61/245,813, filed on Sep. 25, 2009.

(51) Int. Cl. H04N 9/80

(52) U.S. Cl. 386/241

(57) ABSTRACT

Systems and methods according to the exemplary embodiments provide for bookmarking of content in IPTV systems. Upon receipt of a bookmark storing request, an IPTV server can obtain information associated with the content to be bookmarked from an electronic program guide (EPG). The IPTV server can then determine a position in the content at which the content is to be bookmarked based upon the information received from the EPG. A bookmark can then be stored by the IPTV server including a content identifier and the position.

### RELATED APPLICATION

The present application is related to, and claims priority from, U.S. Provisional Patent Application No. 61/245,813, filed Sep. 25, 2009, entitled “Determining Contents and Their Identifiers for Bookmarking Purposes in Content-On-Demand Delivery”, to George Foti, the disclosure of which is incorporated herein by reference.

### TECHNICAL FIELD

The present invention relates generally to communications systems and in particular to methods and systems for bookmarking in IPTV systems.

### BACKGROUND

As technology advances, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at a home. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet, and associated communication streams, has also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services can include Internet Protocol television (IPTV, referring to systems or services that deliver television programs over a network using IP data packets), video on demand (VOD), voice-over-IP (VoIP), and other web related services.

To accommodate the new and different ways in which IP networks are being used to provide various services, new network architectures are being developed and standardized. One such development is the Internet Protocol Multimedia Subsytem (IMS). IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer.

In IPTV systems, network-based bookmarking is an important application that allows users to mark a point in a specific content which is being delivered to their output device (e.g., web TV, user equipment (UE), or the like), for example a streamed TV program, for later viewing starting from that bookmarked point. Network-based bookmarking is very closely tied to the content being viewed since the identity of the content being viewed is an important element that needs to be transmitted to the network for properly saving the bookmark state for later retrieval.

This implies that every application associated with the content being viewed should have some aspect of bookmarking capability. There are various applications associated with delivered content such as scheduled content (linear TV), content on demand, user generated content, etc. However, requiring all of these applications to include its own, distinct bookmarking capability is not very attractive because of the complexity of such a solution and further because of the lack of a common solution shareable between distinct platforms.

### SUMMARY

Exemplary embodiments describe network-based bookmarking mechanisms which can, for example, acquire information from an electronic program guide (EPG) to assist in the determination of a correct content identifier and/or position elements of a bookmark to be stored in the network.

According to one exemplary embodiment a method for network-based bookmarking of content which is currently being output at an end user device, includes the steps of receiving, by an IPTV server, a bookmark storing request signal, the bookmark storing request signal including a content identifier associated with the content to be bookmarked, obtaining, by the IPTV server, information associated with the content to be bookmarked from an electronic program guide (EPG), determining, by the IPTV server, a position in the content at which the content is to be bookmarked based upon the information received from the EPG, and storing, by the IPTV server, a bookmark including the content identifier and the position.

According to another exemplary embodiment a communication system includes an IPTV server having a processor configured to receive a bookmark storing request signal, the bookmark storing request signal including a content identifier associated with the content to be bookmarked and further configured to obtain information associated with the content to be bookmarked from an electronic program guide (EPG), wherein the processor is further configured to storing a bookmark including the content identifier and the position.

According to yet another exemplary embodiment, a computer-readable medium containing instructions which, when executed on a processor or computer, perform the steps of receiving a bookmark storing request signal, the bookmark storing request signal including a content identifier associated with the content to be bookmarked, obtaining information associated with the content to be bookmarked from an electronic program guide (EPG), determining, by the IPTV server, a position in the content at which the content is to be bookmarked based upon the information received from the EPG, and storing a bookmark including said content identifier and said position.

### BRIEF DESCRIPTION OF THE DRAWINGS

The accompanying drawings illustrate exemplary embodiments, wherein:

FIG. 1 illustrates a communication system according to an exemplary embodiment;

FIG. 2 illustrates an exemplary IPTV portion of the communication system of FIG. 1 in more detail;

FIG. 3 is a signaling diagram illustrating systems and methods for network-based bookmarking according to an exemplary embodiment;

FIG. 4 is an XML schema associated with bookmarks according to an exemplary embodiment;

FIG. 5 is flow chart illustrating a method for network-based bookmarking according to an exemplary embodiment; and

FIG. 6 is an IPTV server according to an exemplary embodiment.

### ACRONYM LIST

ASM Authentication Session Management
CC Cluster Controller
CDNC Content Delivery and Network Control
CDF Content Delivery Function
CoD Content on Demand
FE Functional Entity
IG IMS Gateway
IMS IP Multimedia Subsystem
IP Internet Protocol
IPTV IP Television
OIPF Open IPTV Forum
OITF Open IPTV Terminal Function
RAC Resource Admission Control
RTSP Real Time Streaming Protocol
URL Uniform Resource Locator
XML eXtensible Markup Language

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

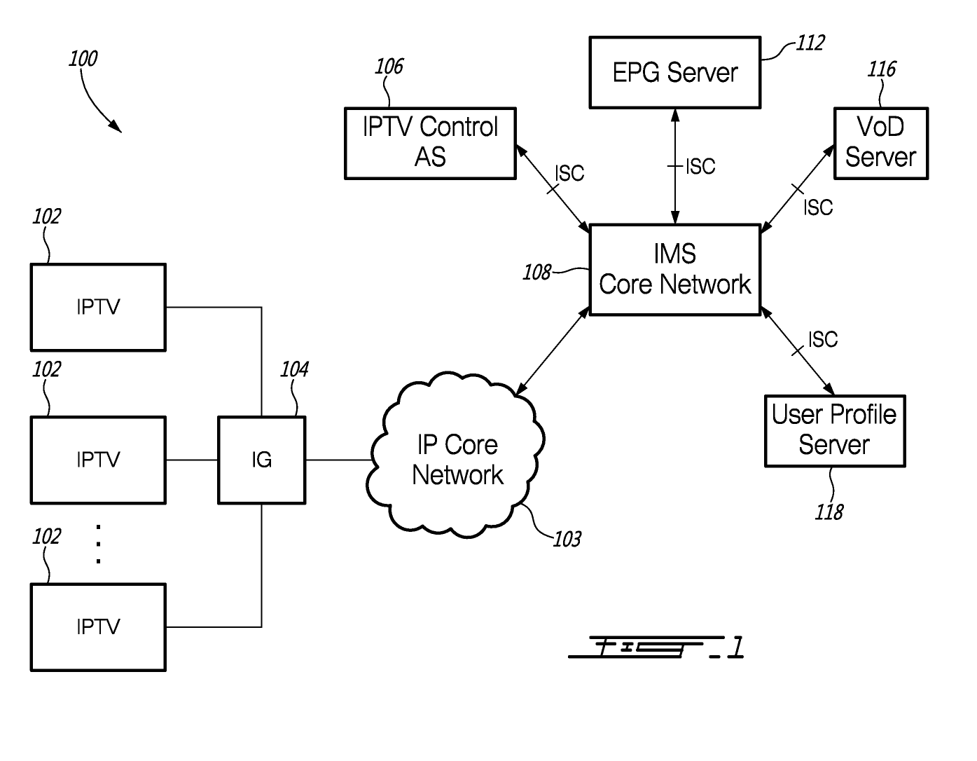

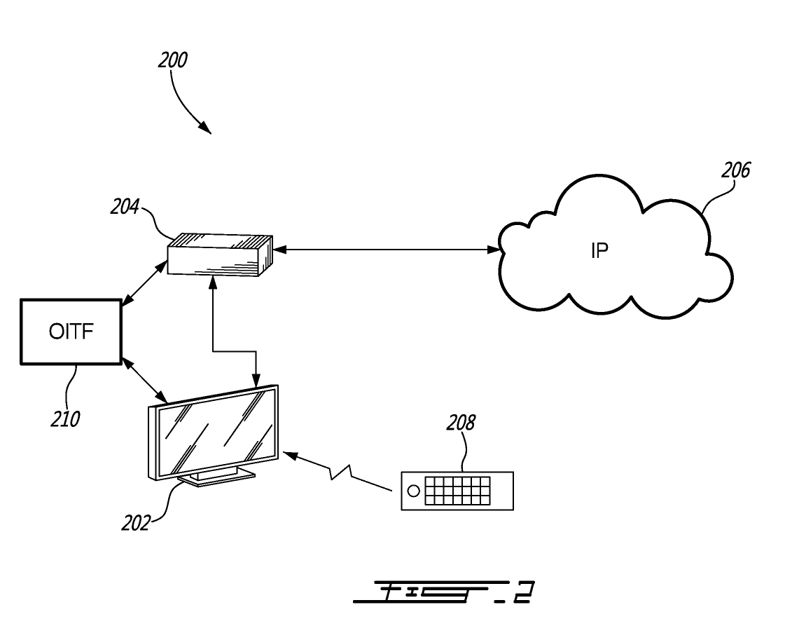

In order to provide some context for this discussion, FIG. 1 illustrates an exemplary communications network 100 in which these exemplary embodiments can be implemented. Therein, a number of IPTV end user equipments 102, e.g., televisions and/or set-top boxes, are connected to an IP core network 103 via an IMS gateway (IG) and access router 104. IPTV communications between the end user equipments 102 and the IPTV control application server 106 are provided via the IP core network 103, e.g., potentially including the Internet, and an IMS core network 108. An electronic program guide (EPG) server 112, a video-on-demand (VoD) server 116 and a user profile server 118 are also connected to the IMS core network 22, e.g., via the IMS Service Control (ISC) interface.

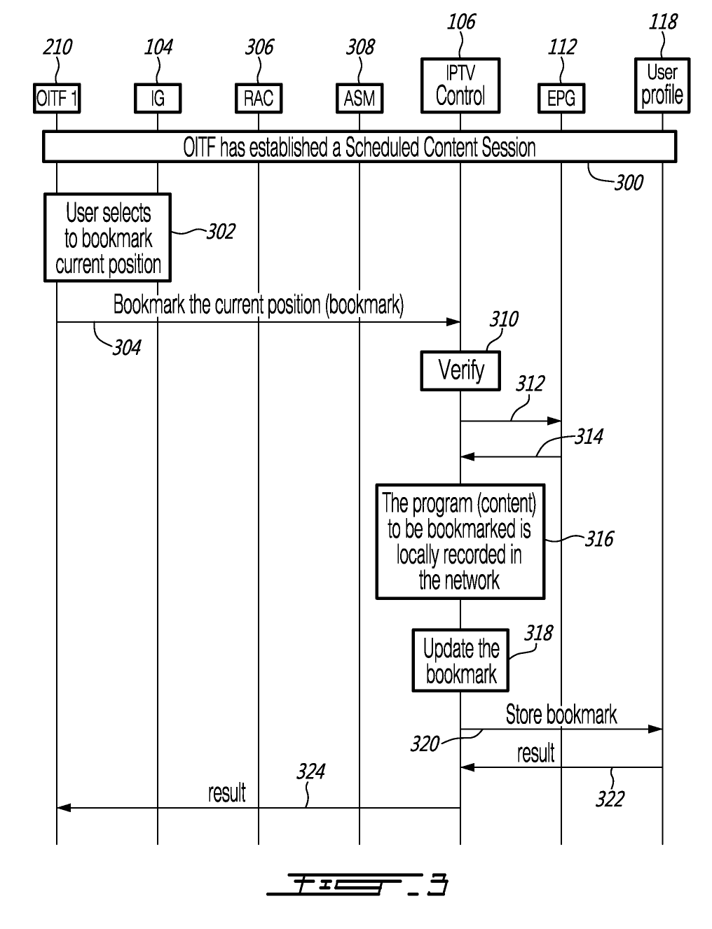

IPTV is a service which provides digital television signals delivered using IP over a network architecture (such as IMS) and may be combined with telephone services (such as VoIP), web access and VoD. An exemplary user side of an IPTV system from which network-based bookmarking may be initiated according to these exemplary embodiments will now be described as shown in FIG. 2. Therein, the IPTV system 200 includes an IPTV (web TV) 202, a set-top box 204 and a connection to the IP network 206. The IPTV 202 is capable of displaying a variety of video signals, associated with different content types described below, and can also be used for voice communications. In particular IPTV 202 is capable of receiving signals using IP protocols either directly or via set-top box 204. Set-top box 204 typically acts to control inputs to IPTV 202, can contain a removable smart card (not shown) such as an IP multimedia services identity module (ISIM) application on a universally integrated circuit card (UICC) and is in communications with both IPTV 202 and IP network 206 (potentially through an IG 104, if not integrated therewith). The UICC contains memory within which security information and applications can be stored. A remote control device 208 may, for example, communicate wirelessly (e.g., via IR or RF) to provide inputs to the IPTV 202 and/or set-top box 204, including a command from the user to bookmark a current delivered content which is being output on the IPTV 202 at a particular point in time. An Open ITV Terminal Function (OITF) 210 runs on either (or is distributed between) IPTV 202 and set-top box 204. The OITF 210, among other things, processes a bookmarking command received from a user watching content on his or her end user device 102, 202 as will be described in more detail below For the interested reader, many more details regarding IPTV systems in general are described in the standard specification OIPF-T1-R2-Functional Architecture V 2.0, Sep. 8, 2009, promulgated by the Open IPTV Forum, the disclosure of which is incorporated here by reference. A discussion of bookmarking in that document is found on pages 119-127.

Using the above-described exemplary IPTV and IMS architectures shown in FIGS. 1 and 2, an end user can obtain a number of different types of content via his or her IPTV 202 including, for example, scheduled content (also sometimes referred to as “linear television”), unscheduled or content-on-demand (CoD), and user generated content, among other types of content. An example of scheduled content is a television program which is broadcast at a particular time to a plurality of users (or other scheduled, multicast content) that is transmitted from a content server (not shown, which may or may not be co-located with EPG server 112 which contains program listing information such as schedules), through the system illustrated in FIGS. 1 and 2, to an end user device 102, 202. An example of CoD content is a movie (or other unscheduled, unicast content) ordered by an end user from a service operating the VoD server 116, which movie is transmitted through the system illustrated in FIGS. 1 and 2 to an end user device 102, 202.

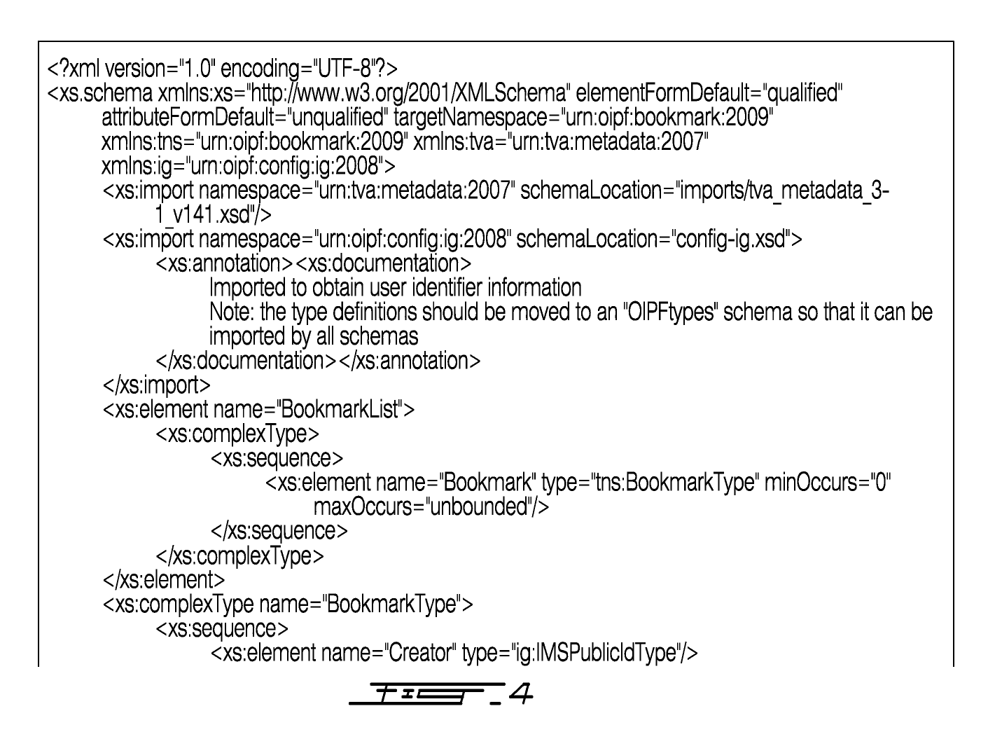

When a user is watching and/or listening to any of these types of content (or some other type of content) on his or her end user device 102,202, she or he may want to stop watching and/or listening to that content and have the network “save” her or his place in that program so that she or he may continue the content at a later time or date from the stopping point. A bookmark provides a mechanism to identify a specific point in time during the play out of a content item so that, when stored in the network and later retrieved, the content can be restarted at the desired point in time. According to exemplary embodiments, a mechanism and process are provided which enable the network to generate and store a bookmark for the stopped content. An example of such mechanisms and processes will now be discussed starting with reference to the signaling diagram of FIG. 3.

Therein, starting at the top of the figure, the OITF 210 has already established a scheduled content session between its associated end user device 102, 202 and the IPTV control server 106, as represented by block 300. This can be accomplished by, for example, performing signaling described in the above-incorporated by reference Open IPTV Forum specification document. At some point in time, the user decides to bookmark the content at its current position so that she or he can later finish watching and/or listening to that content as indicated by block 302. This can be indicated to the user's local system by, for example, providing a user input via the remote control device 208 indicating that he or she wants to bookmark the content.

In response to this, or some other type of input, the OITF 210 associated with the end user device 102, 202 transmits a bookmark storing request signal 304 through the network toward the IPTV control server AS 106. Although shown as a single arrow 304 in FIG. 3, it will be appreciated by those skilled in the art that the bookmark request storing signal can be implemented as a series of signals between the nodes indicated in the figure. For example, the OITF 210 can transmit an HTTP signal carrying a bookmark storing request message 304 to the IG 104, which can in turn forward the bookmark storing request message 304 to a Resource and Admission Control (RAC) subsystem 306 portion of the IMS core network 108 via a SIP signal. SIP is a transaction-oriented, text-based protocol for which more information can be found in the standards document referred to as “RFC 3261, SIP: Session Initiation Protocol”, promulgated by the Network Working Group and downloadable at http://www.ietf.org/rfc/rfc3261.txt. The RAC 306 can, in turn, forward the bookmark storing request message 304 to an Authentication Session Management (ASM) node 308, which then proxies the SIP signal including the bookmark storing request message 304 to the IPTV control AS 106. The corresponding arrows associated with this series of signals are omitted to simplify the figure, and those skilled in the art will appreciate that other signaling mechanisms could be used to transmit the bookmark request storing signal to the IPTV control AS 106.

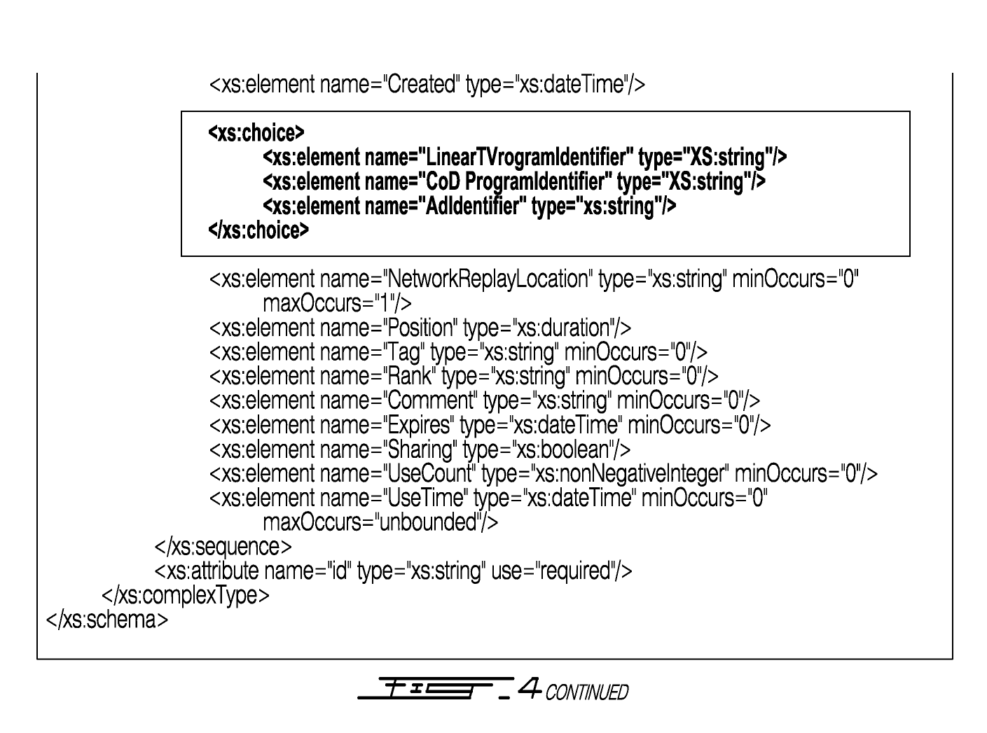

The bookmark storing request message 304 may include information which is available to the OITF 210 related to the content which is currently being watched on the end user device 102, 202 and which information may take the form of an XML schema. An example of an XML schema (which represents an exemplary, stored bookmark) is shown in FIG. 4. The bookmark storing request message 304 will typically include some of the information elements shown in the exemplary XML schema of FIG. 4, or may use a different format altogether. Thus, the information elements in the XML schema of FIG. 4 may either be filled in by the OITF 210 or by the network (the latter especially in the cases where the OITF does not have the capability to provide certain elements).

Of particular interest for the discussion of these exemplary embodiments are the information elements associated with content identifiers and position. In the example of FIG. 4, the “choice” elements (highlighted) are examples of content identifiers and the “Position” element is an example of a position identifier. According to exemplary embodiments, although the OITF 210 may send at least some of the information elements associated with the content to be bookmarked to the network, it is generally the responsibility of the network to verify such information prior to storing it as part of the bookmark. For example, the network should ensure that the right content identifier is present in the XML schema which it receives in the bookmark storing request signal 304 prior to storing that information as part of a bookmark in a user service profile in user profile server 118 for later retrieval. This verification process is generally indicated by block 310.

In addition, according to exemplary embodiments, it is generally the responsibility of the network to identify, for example based on the content, a location (position) where the bookmark is desired for the content to be retrieved later. The manner in which the position is determined may vary depending upon the type of content which is to be bookmarked. For the example of FIG. 3, the content is some type of scheduled content. According to exemplary embodiments, if the bookmark request originates from an OITF 210 that is displaying scheduled content, e.g., a broadcast TV program, the IPTV control AS 106 may consult an electronic program guide (EPG), e.g., an EPG operating on EPG server 112. This consultation between the IPTV control AS 106 and the EPG 112 is indicated by signals 312 and 314 in FIG. 3. The IPTV control AS 106 may then determine the position within the content to be bookmarked based upon information received from the EPG 112 and information received in the bookmark storing request signal, e.g., based on a current time, i.e., the time at which the bookmark request storing signal is received, and start time of the program, i.e., the scheduled start time of the content received from the EPG 112.

The content identifier may also be fetched from the EPG 112 and included in the bookmark XML schema before it is stored in the users profile. Additionally, as shown in block 316, the IPTV control AS 106 determines that the program (content) to be bookmarked is stored in the network (since the bookmark is only useful if the user can later retrieve the stored content). Then, the bookmark is updated by the IPTV control AS 106 at block 318, e.g., to include the correct content identifier, the position and an address (for example a uniform resource locator (URL)) which indicates the location of the stored content before storing the bookmark in the user profile 118 as indicated by signal 320. Signal 320 thus represents an initiation by the IPTV control AS 106 of the storage of the bookmark (e.g., by sending an instruction signal 320 to the user profile server 118 to store the bookmark). An acknowledgement (result) signal 322, 324 can be promulgated back through the network to provide a confirmation that the bookmark was successfully saved to the OITF 210 and can include a URL provide by the network for later usage by the end-user.

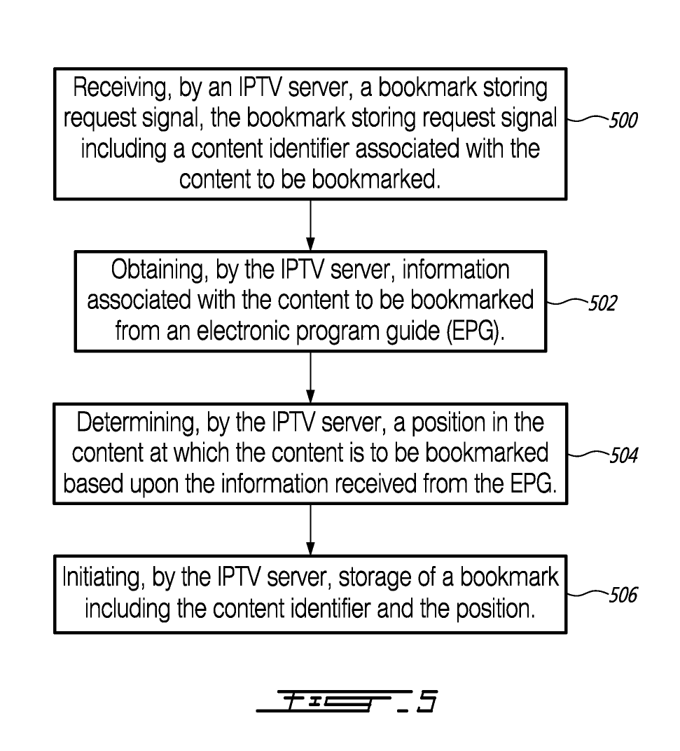

Thus, according to an exemplary embodiment, a method for network-based bookmarking of content which is currently being output at an end user device can include the steps illustrated in the flowchart of FIG. 5. Therein, at step 500, a bookmark storing request signal is received by an IPTV server, the bookmark storing request signal including a content identifier associated with the content to be bookmarked. The IPTV server, at step 502, obtains information associated with the content to be bookmarked from an electronic program guide (EPG), e.g., its scheduled start time. At step 504, the IPTV server determines a position in the content at which the content is to be bookmarked based upon the information received from the EPG. The bookmark can then be stored, as shown in step 506, by initiating storage of a bookmark from the IPTV server, the bookmark including the content identifier and the position by, for example, instructing the user profile server 118 to store the bookmark. It should be noted that in this context, the IPTV server refers to, for example, a server running software which performs either the IPTV Control/FE function or the IPTV application function, or a combination thereof.

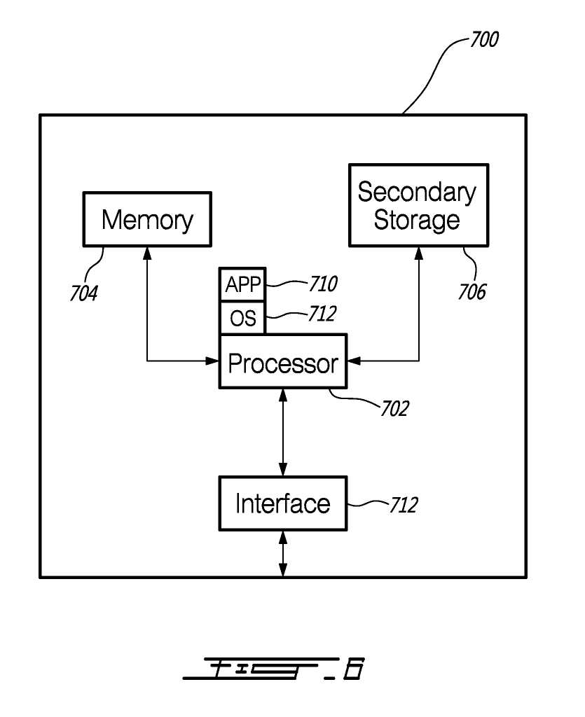

The exemplary embodiments described above provide for messages and protocols involving IPTV servers and other network nodes. An exemplary IPTV server 700 will now be described with respect to FIG. 6. IPTV server 700 can contain a processor 702 (or multiple processor cores), memory 704, one or more secondary storage devices 706 and an interface unit 708 to facilitate communications between IPTV server 700 and the rest of the network. The processor 702 can run, for example, an operating system and an application, e.g., an IPTV Control/FE application and/or an IPTV application, thereon and can be configured to perform the steps described in FIG. 5 above. The memory 704 and/or secondary storage devices 706 represent on example of a computer-readable medium (described below) which contain instructions or software which, when executed on the processor 702 or another computer cause the processor 702 to perform the steps described above, e.g., with respect to FIGS. 3 and/or 5. Similar server structures can also be used for other network nodes described above, e.g., the IMS core network entities.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

It will be appreciated, in accordance with the foregoing exemplary embodiments, that the manner in which the position element of a bookmark is determined will vary, at least in part, based upon the type of media upon which the content being bookmarked is stored in the network. For example, if the scheduled content is stored on tape, then the bookmark is a position on the tape which means that a position which is calculated or determined as a function of time should be mapped into a corresponding tape position. Alternatively, if the scheduled content is stored in a digital file, then the bookmark position is a byte displacement from the beginning of the digital file such that a position which is calculated or determined as a function of time should be mapped into a digital location, e.g., byte position.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for network-based bookmarking of content which is currently being output at an end user device, the method comprising:
receiving, by an IPTV server, a bookmark storing request signal, said bookmark storing request signal including a content identifier associated with the content to be bookmarked;
obtaining, by said IPTV server, information associated with said content to be bookmarked from an electronic program guide (EPG);
determining, by said IPTV server, a position in said content at which said content is to be bookmarked based upon said information received from said EPG; and
initiating, by said IPTV server, storage of a bookmark including said content identifier and said position.

2. The method of claim 1, further comprising:
verifying, by the IPTV server, that said content identifier received in said bookmark request signal is a correct content identifier for said content.

3. The method of claim 1, further comprising:
confirming that said content is stored in a network;
identifying an address associated with a location in said network where said content is stored in said network; and
storing, in said bookmark, said address.

4. The method of claim 3, wherein said address is a uniform resource locator (URL).

5. The method of claim 1, wherein said step of determining said position further comprises:
determining, by said IPTV server, said position based upon both said information received from said EPG and information associated with said bookmark storing request signal.

6. The method of claim 5, wherein said step of determining said position further comprises using a scheduled start time received from said EPG and a time when the bookmark storing request signal is received.

7. A communication system comprising:
an IPTV server including:
a processor configured to receive a bookmark storing request signal, said bookmark storing request signal including a content identifier associated with the content to be bookmarked and further configured to obtain information associated with said content to be bookmarked from an electronic program guide (EPG);
wherein said processor is further configured to initiate storage of a bookmark including said content identifier and said position.

8. The communication system of claim 7, wherein said IPTV server is further configured to verify that said content identifier received in said bookmark request signal is a correct content identifier for said content.

9. The communication system of claim 7, wherein said IPTV server is further configured to confirm that said content is stored in a network, to identify an address associated with a location in said network where said content is stored in said network, and to store, in said bookmark, said address.

10. The communication system of claim 9, wherein said address is a uniform resource locator (URL).

11. The communication system of claim 7, wherein said processor is further configured to determine said position by determining said position based upon both said information received from said EPG and information associated with said bookmark storing request signal.

12. The communication system of claim 11, wherein said processor is further configured to determine said position by using a scheduled start time received from said EPG and a time when the bookmark storing request signal is received.

13. The communication system of claim 11, further comprising: said EPG and a user profile server in which said bookmark is stored by said IPTV server.

14. A computer-readable medium containing instructions which, when executed on a processor or computer, perform the steps of:
receiving, by an IPTV server, a bookmark storing request signal, said bookmark storing request signal including a content identifier associated with the content to be bookmarked;
obtaining, by said IPTV server, information associated with said content to be bookmarked from an electronic program guide (EPG);
determining, by said IPTV server, a position in said content at which said content is to be bookmarked based upon said information received from said EPG; and
initiating by said IPTV server, storage of a bookmark including said content identifier and said position.

15. The computer-readable medium of claim 14, further containing instructions which, when executed on a processor or computer perform the step of:
verifying, by the IPTV server, that said content identifier received in said bookmark request signal is a correct content identifier for said content.

16. The computer-readable medium of claim 14, further containing instructions which, when executed on a processor or computer perform the steps of:
confirming that said content is stored in a network;
identifying an address associated with a location in said network where said content is stored in said network; and
storing, in said bookmark, said address.

17. The computer-readable medium of claim 16, wherein said address is a uniform resource locator (URL).

18. The computer-readable medium of claim 14, wherein said step of determining said position further comprises:
determining said position based upon both said information received from said EPG and information associated with said bookmark storing request signal.

19. The computer-readable medium of claim 18, wherein said step of determining said position further comprises using a scheduled start time received from said EPG and a time when the bookmark storing request signal is received.
